(19) United States
(12) Patent Application Publication
(10) Pub. No.: US 2026/0350704 A1
(43) Pub. Date: Nov. 5, 2026

(54) METHOD AND SYSTEM FOR AI-POWERED REAL-TIME DEBRIEFING AND FEEDBACK IN FINANCIAL PLANNING

(71) Applicant: Jay Zigmont, Mount Juliet, TN (US)

(72) Inventor: Jay Zigmont, Mount Juliet, TN (US)

(21) Appl. No.: 19/194,695

(22) Filed: Apr. 30, 2025

(51) Int. Cl. G06Q 40/06; G06F 40/30; G06V 40/16; G06V 40/20

(52) U.S. Cl. CPC G06Q 40/06; G06F 40/30; G06V 40/174; G06V 40/20

(57) ABSTRACT

An AI-powered method and system for providing real-time debriefing feedback during and after financial planning client meetings. The method involves capturing audiovisual signals and metadata of interactions between a financial planner and a client, analyzing the data using an artificial intelligence engine to detect deviations from established financial planning practices and regulatory compliance requirements, and generating feedback recommendations structured to facilitate experiential learning. The system includes a data acquisition module, a processor, a memory, and an artificial intelligence engine configured to analyze verbal and non-verbal cues, determine debriefing outcomes, and generate feedback recommendations in accordance with a framework comprising defusing, debriefing, and deepening steps. Feedback is delivered via an interactive interface during or immediately after the meeting, and meeting data is stored securely for iterative comparison to track performance trends. Principal uses include improving financial planning, enhancing communication, and addressing compliance risks.

### FIELD OF THE INVENTION

The present disclosure relates to artificial intelligence and financial technology, specifically to systems and methods for providing real-time, AI-powered debriefing feedback to enhance financial planning practices and compliance.

### BACKGROUND OF THE INVENTION

The field of financial planning is characterized by the dual demands of technical expertise and effective interpersonal communication. Professionals in this domain collaborate with clients to develop thorough strategies that address both short-term financial needs and extended objectives. Traditional approaches in this area have often relied on substantial experience and mentorship, allowing practitioners to build knowledge over years of practice. However, the complexity of modern financial advising that integrates behavioral finance concepts with intricate regulatory requirements, and multifaceted client interactions, calls for methods that support ongoing learning and swift integration of complex feedback. Such an environment highlights the importance of having accessible mechanisms to foster enhanced practice and adaptability in a dynamic, competitive landscape.

A central goal in financial planning is to provide timely, constructive insights that enable advisors to refine their skills and enhance client outcomes. In regulated environments, where precision and compliance are of significant importance, there is a clear intent to bridge the gap between theoretical knowledge and practical application. Advisors strive to integrate real-time evaluative inputs into their daily client interactions to foster a cycle of immediate reflection and adjustment. The broader aim is to create a professional setting that supports iterative experiential learning, ensuring that each client engagement serves as an opportunity for incremental improvement across communication strategies, decision-making processes, and regulatory adherence.

Despite the recognized benefits of immediate feedback in professional settings, conventional methods have struggled to meet the dynamic needs of financial planning. Traditional mentorship programs, while beneficial, generally offer feedback in a delayed and piecemeal fashion. This lag can hinder the prompt correction of behaviors or the timely reinforcement of effective strategies. In fast-evolving business environments, the absence of a mechanism that delivers continuous, contextually relevant evaluation may lead to the persistence of suboptimal practices. As a result, the overall efficiency and performance of financial advisory services can suffer, as sustained learning is impeded by gaps in the regular, immediate feedback cycle.

Within financial planning, the scarcity of timely guidance and structured debriefing magnifies challenges associated with skill development and compliance management. Financial advisors often operate without immediate access to expert evaluation following client interactions, which leaves limited room for rapid reflection and swift course correction. This lack of immediate, detailed review may result in missed opportunities for reinforcing effective approaches or addressing emerging issues promptly. As a result, the process of refining practice and building confidence in a highly regulated field can be unduly prolonged. There is a significant need for solutions that can facilitate structured, real-time feedback to support continuous improvement and ensure that evolving professional standards and regulatory requirements are consistently met.

### SUMMARY OF THE INVENTION

In one embodiment, the disclosure provides a computer-implemented method for delivering real-time, AI-powered debriefing and feedback for financial planning client meetings. In this method, a processor receives data representing a client meeting, including audiovisual signals and associated metadata that document the interaction between a financial planner and a client. The data is then analyzed by an artificial intelligence engine configured to detect deviations from established financial planning practices and regulatory compliance requirements by evaluating both verbal communications and non-verbal cues such as facial expressions, gestures, and body movements. Based on this analysis, an outcome is determined that identifies one or more areas for improvement in the financial planner's practice. real-time feedback recommendations are generated to facilitate experiential learning and are provided to the financial planner during or immediately following the meeting. Furthermore, the method includes storing the analyzed meeting data and generated feedback for iterative comparison with historical data to track performance trends over successive meetings. In some embodiments, natural language processing and large language models extract semantic and syntactic features from the verbal communications, the recommendations are structured according to a debriefing framework that includes steps for defusing emotional responses, respectively assessing planning decisions through reflective inquiry, and connecting learning to future client meetings, and compliance deviations may trigger corrective instructions, with the AI engine employing machine learning models trained on historical meetings to continuously refine deviation detection.

In another embodiment, the disclosure provides a system for delivering real-time, AI-powered debriefing and feedback for financial planning client meetings. The system comprises a data acquisition module configured to capture audiovisual signals and associated metadata from a client meeting, wherein the module may include one or more cameras and microphones. A processor coupled with a memory stores an artificial intelligence engine that analyzes the captured signals and metadata to detect deviations from established financial planning practices and regulatory compliance requirements through evaluation of both verbal and non-verbal cues. Based on this analysis, the engine determines a debriefing outcome that highlights areas for improvement in adherence to recommended planning processes and generates real-time feedback recommendations structured to facilitate experiential learning. A communications module delivers the recommendations to the financial planner during or immediately following the meeting, for example via an interactive mobile device interface, while a secure data storage module preserves the meeting data and generated feedback in accordance with applicable privacy standards such as HIPAA and SOC 2 and maintains audit logs for compliance monitoring. In certain embodiments, the artificial intelligence engine includes dedicated natural language processing and large language models and image processing modules to extract semantic and syntactic features from speech and to analyze visual cues, respectively, and the system may further incorporate a user interface for displaying historical performance trends and debriefing outcomes derived from iterative comparisons of analyzed meeting data. Additionally, the processor may be configured to execute real-time analysis, and the AI engine may iteratively update a knowledge base based on feedback from successive meetings to enhance the accuracy of performance trend tracking and feedback recommendation generation.

### BRIEF DESCRIPTION OF DRAWINGS

FIG. 1 is a schematic block diagram illustrating the architecture of a computing system configured to implement real-time, AI-powered debriefing and feedback for financial planning client meetings.

FIG. 2 is a schematic block diagram illustrating a computing system configured to implement real-time, AI-powered debriefing and feedback for financial planning client meetings.

FIG. 3 is a block diagram illustrating the evaluation framework for generating planner feedback based on client meeting data and established standards.

### BEST MODE FOR CARRYING OUT THE INVENTION

The best mode for carrying out the invention involves implementing a system and computer-implemented method for providing real-time, AI-powered debriefing feedback during financial planning client meetings. The system includes a data acquisition module, a processor, a memory, and an artificial intelligence engine configured to analyze audiovisual signals and metadata captured during the meeting. The AI engine employs natural language processing and large language models, and image processing algorithms to evaluate verbal communications and non-verbal cues, such as facial expressions, gestures, and body movements, to detect deviations from established financial planning practices and regulatory compliance requirements.

The system generates real-time feedback recommendations structured in accordance with a debriefing framework comprising defusing, debriefing, and deepening steps. These recommendations are delivered to the financial planner during or immediately following the meeting via an interactive mobile device interface. The system also includes a secure data storage module that stores meeting data and feedback recommendations in compliance with privacy standards such as HIPAA and SOC 2, ensuring confidentiality and regulatory adherence.

The AI engine is trained on a dataset comprising best practices, company standards, behavioral finance concepts, historical financial planning meetings, debriefing outcomes, and exemplar practices, enabling it to refine its detection capabilities and feedback generation over time. The system further incorporates a user interface for displaying historical performance trends and debriefing outcomes derived from iterative comparisons of analyzed meeting data. This iterative process allows financial planners to track their progress and continuously improve their practice.

The best mode also includes the ability to detect significant compliance deviations during client meetings and provide corrective instructions to address identified risks. The AI engine updates its knowledge base iteratively based on feedback from successive meetings, enhancing the accuracy of performance trend tracking and feedback recommendation generation. This implementation ensures that financial planners receive timely, constructive feedback to improve their adherence to recommended practices, enhance communication strategies, and address compliance risks effectively.

### DETAILED DESCRIPTION OF THE INVENTION

The field of financial planning is characterized by the dual challenges of technical complexity and the need for effective interpersonal communication. Financial planners are responsible for creating thorough strategies that address immediate financial needs, behavioral finance concepts, and long-term objectives for their clients. This process involves not only a deep understanding of financial principles and behavioral finance concepts but also the ability to navigate complex regulatory environments and foster trust through effective client interactions. Although these skills are highly significant, the development of expertise in financial planning often depends on years of experience and mentorship, which may not be readily accessible. The lack of structured, real-time feedback mechanisms further complicates the learning process, leaving financial planners to rely on delayed or incomplete evaluations of their performance.

Existing methods for skill and expertise development in financial planning, such as traditional mentorship programs and periodic performance reviews, have significant limitations. Mentorship programs, while beneficial, are resource-intensive and often provide feedback in a delayed and fragmented manner. This lag in feedback can hinder the timely correction of suboptimal practices and the reinforcement of effective strategies. Similarly, periodic reviews are typically retrospective and fail to offer the immediacy required for real-time course correction. In fast-paced and highly regulated environments, these limitations can result in prolonged learning curves, persistent inefficiencies, and increased risks of non-compliance. Moreover, the lack of immediate, structured feedback mechanisms can lead to missed opportunities for professional growth and the perpetuation of ineffective practices.

The present disclosure addresses these challenges by providing a computer-implemented method and system for delivering real-time, AI-powered debriefing feedback during financial planning client meetings. The described approach leverages advanced artificial intelligence technologies, including natural language processing, large language models, and image processing, to analyze both verbal and non-verbal cues captured during client interactions. By detecting deviations from established financial planning practices, behavioral finance concepts, and regulatory compliance requirements, the system generates actionable feedback recommendations in real-time. These recommendations are structured to facilitate experiential learning and are delivered to financial planners during or immediately following client meetings. The described system also incorporates mechanisms for iterative performance tracking, enabling planners to monitor their progress over time and continuously refine their skills. By addressing the limitations of traditional feedback methods, the described approach provides a scalable, efficient, and effective solution for enhancing financial planning practices and ensuring compliance with regulatory standards.

The computer-implemented method enables financial planners to receive immediate, actionable feedback during or immediately following client meetings by leveraging an artificial intelligence engine to analyze audiovisual signals and metadata. This arrangement allows for the detection of deviations from established financial planning practices and regulatory compliance requirements in real-time, which is not feasible with traditional mentorship or periodic review methods. By evaluating both verbal communications and non-verbal cues, such as facial expressions and gestures, the system provides a comprehensive analysis of the interaction, ensuring that feedback is contextually relevant and precise.

The generation of structured feedback recommendations facilitates experiential learning by aligning with established debriefing frameworks, such as defusing emotional responses, reflective inquiry, and connecting insights to future practice. This structured approach accelerates the learning curve for financial planners, enabling them to refine their skills and improve client outcomes more efficiently than conventional methods.

The storage of analyzed meeting data and feedback for iterative comparison with historical data introduces a longitudinal tracking mechanism. This capability facilitates the identification of performance trends over successive meetings, enabling planners to monitor their progress and address recurring issues systematically. Furthermore, the iterative comparison enhances the AI engine's ability to refine the generation of feedback, promoting ongoing improvement in the quality of recommendations provided.

By integrating real-time analysis, structured feedback delivery, and iterative performance tracking, the method addresses the limitations of delayed and fragmented feedback in traditional systems, offering a scalable and efficient solution for skill development and compliance management in financial planning.

The system provides real-time, AI-powered debriefing feedback for financial planning client meetings, comprising a data acquisition module, a processor, a memory, an artificial intelligence engine, a communications module, and a secure data storage module.

The arrangement of the data acquisition module, which includes cameras and microphones, enables the system to capture audiovisual signals and metadata from client meetings. This physical configuration ensures thorough data collection, including verbal and non-verbal cues, which are important for analyzing the interaction between the financial planner and the client. By capturing both types of cues, the system provides a more comprehensive evaluation of the meeting, addressing gaps in traditional feedback mechanisms that rely solely on verbal communication.

The processor and memory work in conjunction with the artificial intelligence engine to analyze the captured data. The AI engine evaluates deviations from established financial planning practices and regulatory compliance requirements, leveraging natural language processing and large language models and image processing algorithms. This integration allows the system to detect subtle patterns in speech and behavior, such as tone, facial expressions, and gestures, which are often overlooked in manual reviews. The ability to perform this analysis in real-time ensures that feedback is timely and actionable, reducing the delay associated with conventional mentorship or periodic reviews.

The communications module delivers feedback recommendations to the financial planner during or immediately following the client meeting. This immediate delivery mechanism facilitates experiential learning by allowing the planner to reflect on their performance while the interaction is still fresh in their memory. The structured feedback, based on frameworks such as defusing emotional responses, reflective inquiry, and deepening insights, accelerates the learning process and enhances the planner's ability to adapt their strategies for future meetings.

The secure data storage module ensures that meeting data and feedback recommendations are stored in compliance with privacy standards such as HIPAA and SOC 2. This feature addresses the significant need for confidentiality in financial planning, where sensitive client information is handled. Additionally, the storage module supports iterative comparison with historical meeting data, enabling longitudinal tracking of performance trends. This capability allows planners to monitor their progress over time and identify recurring issues, fostering ongoing improvement.

By combining real-time analysis, structured feedback delivery, and secure data storage, the system provides a scalable solution for skill development and compliance management in financial planning in real-time. This arrangement addresses the limitations of traditional mentorship programs, which are resource-intensive and often provide delayed feedback, and periodic reviews, which lack immediacy and depth. The system's ability to deliver timely, comprehensive, and actionable feedback enhances the efficiency and effectiveness of financial planners, leading to improved client outcomes and reduced compliance risks.

In one embodiment, the system for providing real-time AI-powered debriefing feedback for financial planning client meetings may utilize a cloud-based architecture where the artificial intelligence engine is hosted on a remote server, enabling scalability and accessibility across multiple devices and locations. In another embodiment, the system may be implemented as an on-premises solution, where the artificial intelligence engine and data storage modules are installed locally within the financial planning firm's infrastructure to ensure enhanced control over sensitive client data and compliance with stringent privacy regulations. The audiovisual data acquisition module may vary in its configuration; for instance, it could include high-definition cameras and directional microphones for capturing detailed facial expressions and nuanced verbal cues, or simpler, lower-resolution devices for cost-effective deployment in smaller firms. In yet another embodiment, the system may integrate wearable devices, such as smart glasses or headsets, equipped with embedded cameras and microphones to unobtrusively capture meeting data and provide real-time feedback while maintaining a natural interaction environment. The communication module delivering feedback recommendations may be embodied as a mobile application, a desktop interface, or even a voice-activated assistant that provides real-time auditory feedback during the meeting. Additionally, the artificial intelligence engine may employ different machine learning models tailored to specific use cases, such as deep learning algorithms for complex behavioral analysis or rule-based systems for straightforward compliance checks. The secure data storage module may be implemented using various technologies, such as encrypted cloud storage for remote access or blockchain-based systems for immutable audit trails. These embodiments demonstrate the adaptability of the system to diverse operational environments and technological configurations while maintaining its functionality of providing real-time feedback to financial planners.

In one embodiment, the data acquisition module may include a combination of high-definition cameras and directional microphones strategically positioned within a meeting room to capture audiovisual signals and metadata with enhanced clarity and precision. In another embodiment, the data acquisition module may be implemented as a wearable device, such as smart glasses or a lapel-mounted camera and microphone, allowing for portability and use in various meeting environments, including remote or outdoor settings. In yet another embodiment, the data acquisition module may integrate with virtual meeting platforms, such as video conferencing software, to directly capture audiovisual signals and metadata from digital interactions. The artificial intelligence engine may, in one embodiment, utilize a cloud-based architecture to perform real-time analysis, enabling scalability and seamless integration across multiple financial planning offices. Alternatively, the artificial intelligence engine may be implemented as an edge computing solution, where the analysis is performed locally on a dedicated device to ensure low latency and enhanced data privacy. The communications module, in one embodiment, may deliver feedback through a mobile application interface, providing interactive visualizations and actionable insights to the financial planner. In another embodiment, the communications module may utilize augmented reality (AR) technology to overlay feedback directly onto the planner's view of the meeting environment, enhancing situational awareness. The secure data storage module, in one embodiment, may employ blockchain technology to ensure tamper-proof storage of meeting data and feedback, while in another embodiment, the secure data storage module may utilize traditional encrypted databases with multi-factor authentication to comply with stringent privacy standards such as HIPAA and SOC 2. Additionally, the system may include a user interface that, in one embodiment, provides a dashboard displaying real-time performance metrics and historical trends, while in another embodiment, the user interface may offer a voice-activated assistant to guide the financial planner through feedback and recommendations.

In one embodiment, the system employs a natural language processing (NLP) and large language models module (LLM) that utilizes transformer-based models, such as GPT or BERT, to extract semantic and syntactic features from the verbal communications of the financial planner and client. This embodiment facilitates nuanced understanding of conversational context, including detecting tone, sentiment, and intent. In another embodiment, the NLP or LLM module is configured to use rule-based algorithms combined with keyword extraction techniques, which may be more appropriate for environments with constrained computational resources or where predefined compliance rules are emphasized. In yet another embodiment, the NLP or LLM module integrates multilingual capabilities, enabling the system to analyze verbal communications in multiple languages, thereby supporting financial planners and clients in diverse linguistic settings. Additionally, the NLP or LLM module may be implemented with real-time processing capabilities, enabling immediate feedback during the client meeting, or with batch processing capabilities, where verbal communications are analyzed post-meeting for detailed feedback. The module may also vary in its deployment, such as being hosted on a cloud-based infrastructure for scalability or embedded within local hardware for enhanced data security. Furthermore, the NLP or LLM module can be tailored to prioritize particular aspects of communication, such as detecting behavioral finance cues or identifying compliance-related keywords, depending on the organization's operational focus.

In one embodiment, the debriefing framework comprises a defusing module that uses sentiment analysis algorithms to detect emotional responses in the financial planner's verbal and non-verbal cues, such as tone of voice, facial expressions, and body language, and provides tailored prompts to address these emotions. In another embodiment, the defusing module is configured to operate in a text-based environment, analyzing written notes or chat transcripts from virtual client meetings to identify emotional indicators and suggest appropriate interventions. The debriefing module, in one embodiment, employs a natural language processing engine to assess the financial planner's decision-making process by analyzing the sequence and content of their verbal communications during the meeting, comparing them to established practices and regulatory guidelines. Alternatively, the debriefing module may utilize a graphical interface to visually map the planner's decision-making flow, highlighting areas of deviation or improvement. The deepening module, in one embodiment, integrates a recommendation engine that suggests specific learning resources, such as articles, webinars, or company training materials, based on the planner's identified areas for improvement. In another embodiment, the deepening module incorporates a simulation tool that allows the planner to practice applying the feedback in a virtual client meeting environment before their next real-world interaction. The framework may also be adapted to different delivery methods, such as interactive mobile applications, desktop software, or integrated systems within video conferencing platforms, ensuring flexibility in deployment across various operational environments.

In one embodiment, the system stores historical meeting data and associated performance trends in a centralized cloud-based database, enabling seamless access and analysis across multiple devices and locations. This embodiment ensures scalability and supports organizations with distributed teams by providing real-time synchronization of data. In another embodiment, the system utilizes a local server-based storage solution, which may be preferred by organizations with stringent data privacy requirements or limited internet connectivity. This configuration allows for secure, on-premises data management while maintaining compliance with privacy standards such as HIPAA and SOC 2. In yet another embodiment, the storage module is designed to incorporate blockchain technology for enhanced data integrity and tamper-proof audit trails. This approach ensures that historical meeting data and performance trends are securely stored and verifiable, which is particularly beneficial for regulatory compliance and quality assurance purposes. Additionally, the system may include a hybrid storage model, combining cloud-based and local storage solutions to balance accessibility and security. For example, sensitive client data could be stored locally, while anonymized performance trends and analytics are stored in the cloud for broader organizational insights. Each embodiment is configured to enable iterative comparisons of current analyzed meeting data with historical data, facilitating the generation of detailed performance trend reports and supporting continuous improvement in financial planning practices.

In one embodiment, the communications module is implemented as a mobile application on a smartphone or tablet, providing an interactive interface for delivering real-time feedback recommendations to the financial planner. The application may include features such as push notifications, visual dashboards, and voice-assisted feedback to enhance usability. In another embodiment, the communications module is integrated into a desktop software platform, allowing planners to receive feedback through pop-up notifications or detailed reports displayed on their computer screens immediately following client meetings. In yet another embodiment, the communications module is embedded within a wearable device, such as a smartwatch or smart glasses, enabling planners to receive discreet, real-time feedback during client interactions without disrupting the flow of the meeting. Additionally, the communications module could be configured as a cloud-based system accessible via a secure web portal, where planners can log in to review feedback and performance trends at their convenience. In some embodiments, the module may support multi-channel communication, such as email, SMS, or instant messaging, to ensure feedback delivery in environments where planners may not have access to specialized devices or software. Furthermore, the communications module may include adaptive features, such as language translation capabilities, to accommodate planners operating in multilingual environments or serving clients with diverse linguistic needs.

In one embodiment, the system detects significant compliance deviations during financial planning client meetings by employing a rule-based algorithm that cross-references planner actions against a predefined set of regulatory guidelines and company policies. For example, the system may flag instances where sensitive client information is shared via unsecured communication channels, such as email, and immediately generate corrective feedback instructing the planner to use a secure portal for document exchange. In another embodiment, the system utilizes machine learning models trained on historical compliance violations to identify patterns indicative of potential risks, such as recommending corrective actions when a planner fails to adequately disclose investment risks during a client discussion. In yet another embodiment, the system integrates real-time sentiment analysis to detect emotional cues from the client that may signal dissatisfaction or confusion regarding compliance-related topics, prompting the generation of feedback to address these concerns proactively. Additionally, the system may include a customizable compliance monitoring module that allows firms to input specific regulatory requirements tailored to their jurisdiction, ensuring localized compliance deviations are detected and addressed. In a further embodiment, the system could employ a tiered feedback mechanism, where minor compliance deviations result in educational prompts for the planner, while significant violations trigger immediate alerts to compliance officers for further review and intervention. These embodiments demonstrate the flexibility of the system in identifying and addressing compliance deviations across diverse operational contexts and regulatory environments.

In one embodiment, the artificial intelligence engine employs supervised machine learning models trained on a dataset comprising annotated historical financial planning meetings and corresponding debriefing outcomes. These models are designed to detect deviations from established financial planning practices and regulatory compliance requirements by leveraging labeled examples to refine their accuracy. In another embodiment, the artificial intelligence engine utilizes unsupervised learning techniques, such as clustering algorithms, to identify patterns and anomalies in financial planner behavior without requiring pre-labeled data, enabling the system to adapt to new scenarios and uncover latent trends. In yet another embodiment, the engine incorporates reinforcement learning, where the system iteratively improves feedback generation by receiving performance evaluations from planners and management, thereby optimizing recommendations over time. Additionally, the artificial intelligence engine may be implemented using hybrid models that combine natural language processing and large language models (NLP) for analyzing verbal communications with computer vision algorithms for evaluating non-verbal cues, such as facial expressions and gestures. The NLP module may employ transformer-based architectures, such as BERT or GPT, to extract semantic and syntactic features from planner-client dialogues, while the computer vision module may utilize convolutional neural networks (CNNs) to process video data for detecting body language and emotional states. Furthermore, the artificial intelligence engine can be configured to operate in a distributed computing environment, where components are deployed across multiple servers to ensure scalability and real-time processing of large volumes of audiovisual data. In some embodiments, the engine may integrate domain-specific knowledge bases, such as behavioral finance concepts, best practices, financial planning guidelines and compliance regulations, to enhance contextual understanding and accuracy in detecting deviations.

In one embodiment, the artificial intelligence engine is implemented as a cloud-based system, allowing for centralized processing and storage of audiovisual signals and metadata captured during financial planning client meetings. This configuration enables scalability and facilitates updates to the knowledge base of the artificial intelligence engine across multiple users and locations. In another embodiment, the artificial intelligence engine is embedded within a local computing device, such as a desktop computer or server, providing enhanced data security and compliance with strict privacy standards, such as HIPAA and SOC 2. In yet another embodiment, the artificial intelligence engine is integrated into a mobile device application, enabling portability and real-time feedback delivery directly to financial planners during client meetings. The computational architecture of the artificial intelligence engine may also vary, such as employing a combination of natural language processing, large language models modules and image recognition algorithms to analyze verbal and non-verbal cues. Additionally, the artificial intelligence engine may utilize different machine learning models, such as supervised learning for compliance detection or reinforcement learning for iterative improvement of feedback recommendations. The system may further include variations in the data acquisition module, such as using high-definition cameras and directional microphones for enhanced audiovisual signal capture or employing wearable devices to monitor physiological responses of the financial planner and client.

In one embodiment, the data acquisition module comprises a single high-resolution camera and a directional microphone positioned within the meeting room to capture audiovisual signals and metadata from the financial planning client meeting. In another embodiment, the module includes multiple cameras strategically placed to provide a 360-degree view of the room, ensuring comprehensive coverage of all participants' facial expressions, gestures, and body movements, along with an array of microphones configured to capture spatial audio for enhanced clarity of verbal communications. In yet another embodiment, the data acquisition module is integrated into a wearable device, such as smart glasses or a lapel-mounted camera and microphone, allowing the financial planner to unobtrusively record the meeting while maintaining a natural interaction with the client. Additionally, the module may be implemented as a software-based solution that interfaces with existing video conferencing platforms, leveraging their built-in cameras and microphones to acquire audiovisual signals and metadata remotely. The data acquisition module may also include advanced features such as noise-cancellation algorithms to filter out background noise, infrared sensors for capturing non-verbal cues in low-light conditions, or biometric sensors to detect physiological signals, such as heart rate or stress levels, which can provide additional context for analyzing the interaction. These embodiments demonstrate the adaptability of the data acquisition module to various physical configurations, environments, and technological platforms while maintaining its functionality of capturing meeting data for subsequent analysis.

In one embodiment, the artificial intelligence engine includes a natural language processing module that utilizes transformer-based models, such as GPT or BERT, to extract semantic and syntactic features from verbal communications, enabling nuanced analysis of dialogue between the financial planner and the client. In another embodiment, the image processing module employs convolutional neural networks (CNNs) to analyze facial expressions, gestures, and body movements, providing insights into non-verbal cues that may indicate client engagement or discomfort. In yet another embodiment, the artificial intelligence engine integrates a hybrid approach, combining rule-based algorithms with machine learning models to detect deviations from established financial planning practices and regulatory compliance requirements, ensuring adaptability to diverse organizational policies. Additionally, the artificial intelligence engine may be configured to operate on distributed cloud infrastructure, allowing for scalable processing of audiovisual data from multiple simultaneous client meetings. In a further embodiment, the engine incorporates a feedback generation module that adapts recommendations based on the planner's historical performance trends, tailoring feedback to individual learning styles and areas of improvement. The system may also include a customizable framework for structuring feedback, where the defusing, debriefing, and deepening modules can be adjusted to align with specific organizational training protocols or industry standards. Moreover, the artificial intelligence engine may be equipped with multilingual capabilities, enabling use in global financial planning contexts where client meetings are conducted in different languages.

In one embodiment, the secure data storage module is implemented as a cloud-based storage system that adheres to HIPAA and SOC 2 standards, featuring encrypted data transmission and storage protocols to ensure privacy and security. In another embodiment, the secure data storage module is configured as an on-premises server system, allowing financial planning firms to maintain direct control over sensitive client data while still meeting regulatory compliance requirements. In yet another embodiment, the module incorporates a hybrid storage architecture, combining local storage for immediate access and cloud storage for long-term archival and scalability. The secure data storage module may also include advanced access control mechanisms, such as multi-factor authentication and role-based permissions, to restrict access to sensitive data. Additionally, the module can be equipped with automated audit logging capabilities to track all data access and modifications, ensuring compliance monitoring and facilitating regulatory reporting. In one variation, the module integrates with third-party compliance software to provide real-time alerts for potential data breaches or unauthorized access attempts. Furthermore, the secure data storage module may support modular expansion, allowing firms to scale storage capacity as their client base grows, while maintaining compliance with privacy standards.

In one embodiment, the user interface is implemented as a graphical dashboard accessible via a desktop application, providing detailed visualizations of historical performance trends, including charts, graphs, and heatmaps that highlight areas of improvement and compliance adherence. In another embodiment, the user interface is designed as a mobile application with an interactive touch interface, allowing financial planners to access debriefing outcomes and performance metrics on-the-go, with features such as swipe gestures to navigate between client meeting summaries and drill-down options for detailed feedback. In yet another embodiment, the user interface is integrated into a web-based platform, enabling cross-device accessibility and real-time synchronization of data, where planners can log in from any internet-connected device to view their progress and receive feedback. Additionally, the user interface may include voice-activated functionality, allowing planners to query specific performance metrics or request explanations of feedback through natural language commands, enhancing accessibility for users with varying preferences. In some embodiments, the interface may also support augmented reality (AR) overlays, where planners wearing AR glasses can visualize client meeting analytics and feedback in real-time during or immediately after a meeting, providing an immersive and hands-free experience. Furthermore, the user interface may be customizable, allowing firms to tailor the layout, color schemes, and displayed metrics to align with their branding and specific training objectives.

In one embodiment, the artificial intelligence engine employs a natural language processing models module that utilizes transformer-based models, such as GPT or BERT, to extract semantic and syntactic features from verbal communications, enabling nuanced analysis of dialogue between the financial planner and the client. In another embodiment, the image processing module of the artificial intelligence engine incorporates convolutional neural networks (CNNs) to analyze facial expressions, gestures, and body movements, providing insights into non-verbal cues that may influence the debriefing outcome. In yet another embodiment, the artificial intelligence engine is configured to integrate multimodal data analysis, combining verbal and non-verbal cues with metadata such as meeting duration, client demographics, and planner performance metrics to generate more comprehensive feedback recommendations. Additionally, the artificial intelligence engine may be implemented using cloud-based infrastructure to facilitate scalability and real-time processing across multiple client meetings simultaneously, or it may be deployed locally on secure servers to ensure compliance with stringent privacy standards such as HIPAA and SOC 2. The feedback recommendations generated by the artificial intelligence engine can be delivered through various interfaces, including interactive mobile applications, desktop software, or integrated virtual assistant platforms, allowing financial planners to access feedback in a manner aligned with their workflow. Furthermore, the artificial intelligence engine may be trained on diverse datasets, including anonymized historical financial planning meetings, regulatory compliance guidelines, and company-specific operational practices, to continuously refine its ability to detect deviations and provide actionable insights.

In one embodiment, the communications module is configured as a mobile application interface that operates on smartphones or tablets, allowing financial planners to receive real-time feedback recommendations through push notifications or interactive dashboards. In another embodiment, the communications module is integrated into a desktop software platform, enabling planners to access feedback recommendations via pop-up alerts or a dedicated feedback panel during virtual client meetings. In yet another embodiment, the communications module is implemented as a wearable device, such as a smartwatch or smart glasses, providing discreet feedback through haptic signals, visual prompts, or audio cues during in-person client interactions. Additionally, the communications module may be configured to support voice-activated systems, where planners can verbally query the module for clarification or additional insights on the feedback provided. In a further embodiment, the communications module could utilize augmented reality (AR) technology to overlay feedback recommendations directly onto the planner's view during client meetings, enhancing situational awareness and facilitating immediate adjustments to communication strategies. The module may also support multi-channel delivery, such as simultaneous notifications via email, text messages, or secure messaging platforms, ensuring accessibility across diverse operational environments.

In one embodiment, the secure data storage module is implemented as a cloud-based storage system that adheres to HIPAA and SOC 2 standards, featuring encrypted data transmission and storage protocols to ensure privacy and security. In another embodiment, the secure data storage module is configured as an on-premises server system, allowing financial planning firms to maintain direct control over sensitive client data while still meeting compliance requirements. In yet another embodiment, the module incorporates blockchain technology to create immutable audit logs for compliance monitoring, ensuring transparency and traceability of all stored meeting data and feedback recommendations. Additionally, the secure data storage module may include multi-factor authentication mechanisms and role-based access controls to restrict data access to authorized personnel only. In one variation, the module is designed to integrate with third-party compliance software, enabling seamless reporting and monitoring of regulatory adherence. Furthermore, the module may support real-time data synchronization across multiple devices, ensuring planners can access feedback and historical performance trends securely from any location. Moreover, the secure data storage module may be equipped with automated backup systems to prevent data loss and ensure continuity in case of hardware or software failures.

In one embodiment, the artificial intelligence engine is configured to update the knowledge base using a centralized cloud-based architecture, where data from multiple financial planners across an organization is aggregated and analyzed to refine feedback recommendations and performance trend tracking. In another embodiment, the knowledge base update mechanism is implemented locally on individual devices, allowing planners to maintain personalized feedback loops without requiring continuous internet connectivity, thereby enhancing privacy and security. In yet another embodiment, the knowledge base is updated using a hybrid approach, where sensitive client data is processed locally while anonymized metadata is sent to a central server for broader trend analysis and refinement of machine learning models. The knowledge base may also incorporate modular updates, where specific components, such as compliance guidelines or financial planning practices, are updated independently to ensure adaptability to regulatory changes or evolving industry standards. Additionally, the knowledge base update process can be configured to include real-time feedback from planners, enabling the system to learn from user-provided corrections or insights to improve the accuracy and relevance of future recommendations.

In one embodiment, the artificial intelligence engine is configured to update the knowledge base by analyzing audiovisual signals and metadata from financial planning meetings, incorporating feedback from successive meetings to refine the understanding of client-planner interactions. This embodiment may utilize a centralized cloud-based database to store and process the knowledge base, enabling seamless updates across multiple devices and planners within an organization. In another embodiment, the knowledge base update process is performed locally on a secure server within the financial planning firm, ensuring compliance with stringent privacy standards such as HIPAA and SOC 2. The system may also employ different machine learning models for updating the knowledge base, such as supervised learning algorithms trained on labeled datasets of client meetings or unsupervised learning algorithms that identify patterns and anomalies in planner performance over time. Additionally, the knowledge base may be structured to include modular components, such as separate sections for regulatory compliance, behavioral finance, and communication strategies, allowing the artificial intelligence engine to focus updates on specific areas of improvement. In yet another embodiment, the system may integrate external data sources, such as industry practices or regulatory updates, into the knowledge base to ensure that feedback recommendations remain current and relevant. The knowledge base may also be designed to support multilingual capabilities, enabling the system to adapt to planners and clients who communicate in different languages. Furthermore, the system may incorporate a feedback loop mechanism, where planners can manually input observations or corrections into the knowledge base, enhancing its accuracy and adaptability over time.

### DETAILED DESCRIPTION OF THE DRAWINGS

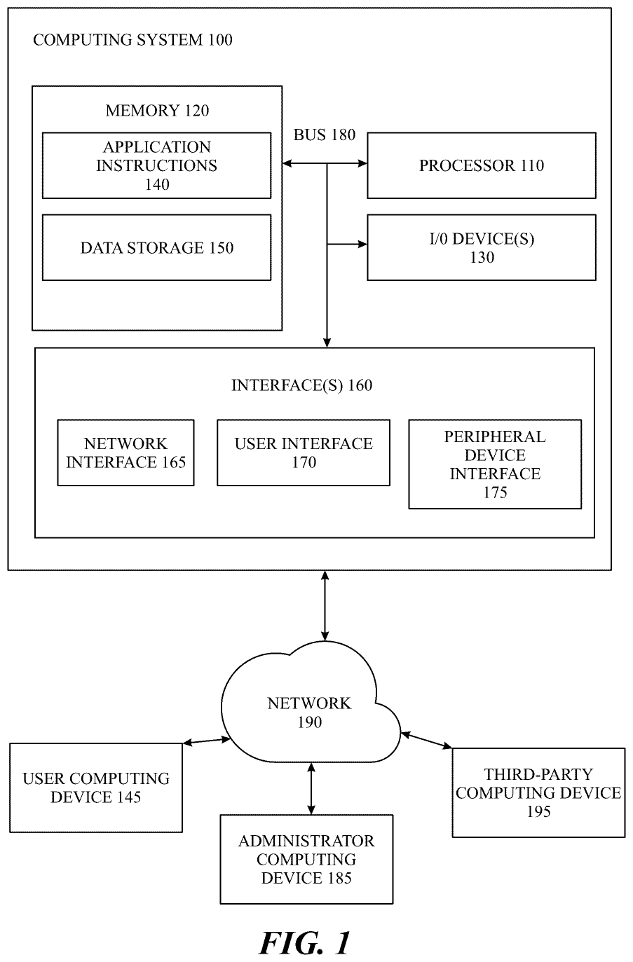

FIG. 1 shows a Computing System 100 configured to implement real-time, AI-powered debriefing feedback for financial planning client meetings. The Computing System 100 comprises a Processor 110, a Memory 120, Application Instructions 140, Data Storage 150, I/O Device(s) 130, Interface(s) 160, a Network Interface 165, a User Interface 170, a Peripheral Device Interface 175, and a Bus 180. The Computing System 100 communicates with a Network 190, which connects to a User Computing Device 145, an Administrator Computing Device 185, and a Third-Party Computing Device 195.

The Processor 110 is operatively connected to the Memory 120 via the Bus 180. The Processor 110 executes Application Instructions 140 stored in the Memory 120 to perform tasks such as analyzing audiovisual signals and metadata captured during financial planning client meetings. The Processor 110 also facilitates the generation of real-time feedback recommendations based on the analysis performed by the artificial intelligence engine.

The Memory 120 stores Application Instructions 140 and Data Storage 150. The Application Instructions 140 include the software logic required to implement the AI-powered debriefing and feedback system, while the Data Storage 150 preserves meeting data, feedback recommendations, and historical performance trends. The Memory 120 ensures that the Computing System 100 can access and process relevant data efficiently.

The IODS 130 are connected to the Processor 110 via the Bus 180 and provide mechanisms for input and output operations. The IODS 130 may include devices such as keyboards, mice, and display screens, enabling interaction with the Computing System 100. These devices facilitate user engagement and allow financial planners to access feedback recommendations and performance metrics.

The Interface(s) 160 serve as a communication bridge between the Computing System 100 and external devices. The Interface(s) 160 include the Network Interface 165, the User Interface 170, and the Peripheral Device Interface 175. The Network Interface 165 enables the Computing System 100 to connect to the Network 190 for data exchange with external computing devices. The User Interface 170 provides a platform for displaying feedback recommendations and performance trends to financial planners. The Peripheral Device Interface 175 facilitates the connection of peripheral devices, such as printers or external storage units, to the Computing System 100.

The Bus 180 interconnects the Processor 110, Memory 120, I/O Device(s) 130, and Interface(s) 160, facilitating seamless communication and data transfer among these components. The Bus 180 is significant in supporting the operational efficiency of the Computing System 100.

The Network 190 connects the Computing System 100 to external devices, including the User Computing Device 145, Administrator Computing Device 185, and Third-Party Computing Device 195. The User Computing Device 145 allows financial planners to access feedback recommendations and performance metrics remotely. The Administrator Computing Device 185 provides administrative control and oversight of the system, enabling configuration and monitoring of compliance standards. The Third-Party Computing Device 195 facilitates integration with third-party services, such as regulatory compliance databases or external analytics platforms, to enhance the functionality of the AI-powered debriefing feedback system.

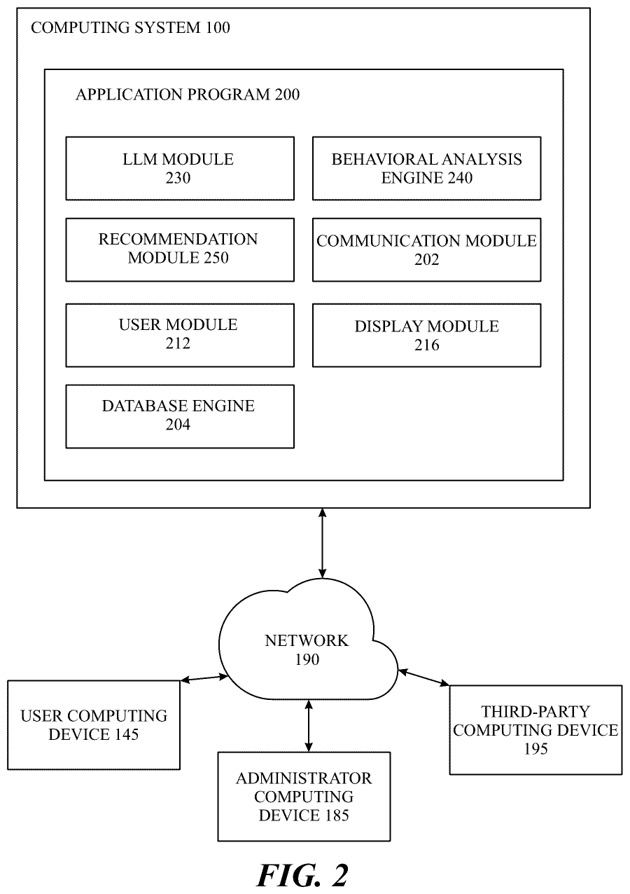

FIG. 2 illustrates a Computing System 100 configured to implement real-time, AI-powered debriefing feedback for financial planning client meetings. The Computing System 100 includes an Application Program 200, which comprises several modules: an LLM Module 230, a Behavioral Analysis Engine (BAE) 240, a Recommendation Module 250, a Communication Module 202, a User Module 212, a Display Module 216, and a Database Engine 204. The Computing System 100 communicates with a Network 190, which connects to a User Computing Device (UCD) 145, an Administrator Computing Device (ACD) 185, and a Third-Party Computing Device (TPCD) 195.

The Application Program 200 is a software framework within the Computing System 100 that orchestrates the functionalities of the constituent modules. The framework operates as the central platform for processing audiovisual signals and metadata captured during financial planning client meetings, facilitating the generation of real-time feedback recommendations.

The LLM Module 230 within the Application Program 200 is responsible for leveraging large language models and natural language processing to process and analyze verbal communications. This module extracts semantic and syntactic features from the interactions between the financial planner and the client, facilitating the detection of deviations from established financial planning practices.

The Behavioral Analysis Engine (BAE) 240 is configured to evaluate non-verbal cues, such as facial expressions, gestures, and body movements, captured during client meetings. The BAE 240 works in conjunction with the LLM Module 230 to provide a comprehensive analysis of both verbal and non-verbal interactions, ensuring accurate and contextually relevant feedback.

The Recommendation Module 250 generates real-time feedback recommendations based on the analysis performed by the LLM Module 230 and the Behavioral Analysis Engine 240. These recommendations are structured to facilitate experiential learning and are delivered to the financial planner during or immediately following the client meeting.

The Communication Module 202 is tasked with transmitting the generated feedback recommendations to external devices. This module facilitates the delivery of actionable insights to the financial planner via interfaces such as mobile applications or desktop platforms.

The User Module 212 provides an interface for financial planners to interact with the system. This module enables users to access feedback recommendations, performance metrics, and historical trends, enhancing their ability to reflect on and improve their practices.

The Display Module 216 is responsible for presenting visual feedback and performance data to the user. This module supports the visualization of trends and recommendations, enabling financial planners to gain a clearer understanding of their progress and areas for improvement.

The Database Engine 204 stores meeting data, feedback recommendations, and historical performance trends. This component facilitates secure and efficient data management, supporting repeated comparisons and extended tracking of performance metrics.

The Network 190 facilitates communication between the Computing System 100 and external devices, including the User Computing Device 145, the Administrator Computing Device 185, and the Third-Party Computing Device 195. The User Computing Device 145 allows financial planners to access feedback remotely, while the Administrator Computing Device 185 provides administrative control and oversight. The Third-Party Computing Device 195 enables integration with third-party services, such as regulatory compliance databases or external analytics platforms, to enhance the system's functionality.

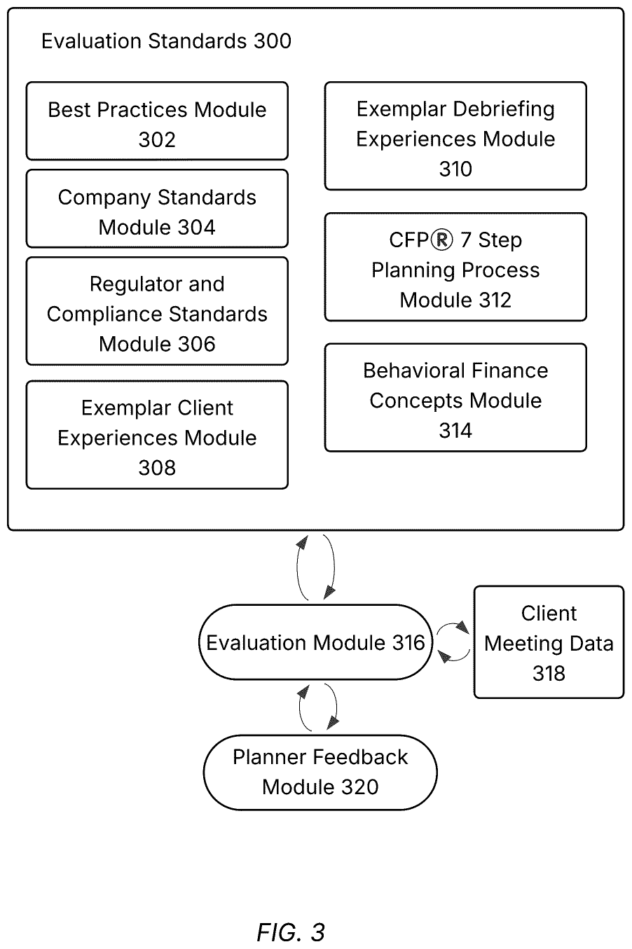

FIG. 3 shows an evaluation framework 300 for generating planner feedback based on client meeting data 318 and established standards. The evaluation framework 300 comprises multiple modules, including a best practices module 302, a company standards module 304, a regulator and compliance standards module 306, an exemplar client experiences module 308, an exemplar debriefing experiences module 310, a CFP® 7-step planning process module 312, and a behavioral finance concepts module 314. The evaluation framework 300 interacts with an evaluation module 316, which processes client meeting data 318 to generate actionable insights. The planner feedback module 320 receives the processed insights and delivers structured feedback to the financial planner.

The practices module 302 is configured to encapsulate widely recognized industry standards and guidelines for effective financial planning. This module provides a repository of established methodologies and techniques that serve as benchmarks for evaluating planner performance. The practices module 302 interacts with other modules to ensure alignment with broader evaluation criteria.

The company standards module 304 integrates organization-specific policies and practices into the evaluation framework 300. This module ensures that the feedback generated aligns with the distinct operational requirements, style, viewpoints and objectives of the financial planning firm. The module operates alongside the regulator and compliance standards module 306 to support adherence to both internal and external guidelines.

The regulator and compliance standards module 306 is designed to evaluate planner actions against regulatory requirements and compliance policies. This module identifies deviations from established legal, compliance, and ethical standards, ensuring that the feedback recommendations address compliance risks in an efficient manner. The regulator and compliance standards module 306 works in conjunction with the behavioral finance concepts module 314 to assess the planner's capacity to manage client interactions that involve compliance considerations.

The client experiences module 308 provides a database of client interactions and outcomes, serving as a reference for evaluating planner performance. This module enables the evaluation standards 300 to compare current client meeting data 318 against reference cases, highlighting areas for improvement and reinforcing effective practices.

The exemplar debriefing experiences module 310 focuses on structured debriefing methodologies that enhance planner learning and skill development. This module provides a framework for generating feedback recommendations that align with experiential learning principles, such as defusing emotional responses, reflective inquiry, and deepening insights.

The CFP® 7-step planning process module 312 incorporates the Certified Financial Planner® Board's established planning process into the evaluation standards 300. This module ensures that feedback recommendations are consistent with recognized professional standards, promoting adherence to a systematic approach in financial planning.

The behavioral finance concepts module 314 evaluates the planner's ability to address psychological and emotional factors influencing client decision-making. This module integrates behavioral insights into the feedback generation process, ensuring that recommendations support effective communication and client engagement strategies.

The evaluation module 316 processes client meeting data 318 by leveraging the evaluation standards 300. The module synthesizes insights from the various components to detect deviations from established standards and generate actionable feedback. The evaluation module 316 ensures that the feedback is contextually relevant and tailored to the specific client interaction.

The client meeting data 318 comprises audiovisual signals and metadata captured during the financial planning client meeting. This data serves as the input for the evaluation module 316, enabling the framework to analyze both verbal and non-verbal cues for comprehensive feedback generation.

The planner feedback module 320 delivers structured feedback to the financial planner based on the analysis performed by the evaluation module 316. This module ensures that the feedback is actionable and aligned with the planner's learning objectives, facilitating continuous improvement in practice and compliance adherence.

I/We claim:

1. A computer-implemented method for providing real-time, AI-powered debriefing and feedback of financial planning client meetings, the method comprising:
receiving, by a processor, data representing a client meeting, the data including audiovisual signals and associated metadata of an interaction between a financial planner and a client; analyzing the received data using an artificial intelligence engine configured to detect deviations from established financial planning practices and regulatory compliance requirements, the analyzing step including evaluation of verbal communications and non-verbal cues of the financial planner and client; determining a debriefing outcome based on the analysis performed in the analyzing step, the debriefing outcome identifying one or more areas for the financial planner to improve practice; generating, via the artificial intelligence engine, real-time feedback recommendations structured to facilitate experiential learning; providing the generated real-time feedback recommendations to the financial planner during or immediately following the client meeting; and storing the analyzed meeting data and generated feedback for iterative comparison with historical data to track performance trends over successive client meetings.

2. The computer-implemented method of claim 1, wherein the analyzing step comprises employing natural language processing and large language models algorithms to extract semantic and syntactic features from the verbal communications of the financial planner and the client.

3. The computer-implemented method of claim 1, wherein the analyzing step further comprises evaluating non-verbal cues by analyzing facial expressions, gestures, and body movements of the financial planner and the client.

4. The computer-implemented method of claim 1, wherein the generated real-time feedback recommendations are structured in accordance with a debriefing framework comprising a defusing step for addressing emotional responses, a reflective inquiry step for assessing planning decisions, and a deepening step for connecting learning to future client meetings.

5. The computer-implemented method of claim 1, further comprising storing historical meeting data and associated performance trends in a database, the storing step configured to enable generation of performance trend reports by iteratively comparing current analyzed meeting data with the historical data.

6. The computer-implemented method of claim 1, wherein providing the generated real-time feedback recommendations comprises transmitting the recommendations via an interactive mobile device interface to the financial planner.

7. The computer-implemented method of claim 1, further comprising detecting significant compliance deviations during the client meeting, and wherein the generated real-time feedback recommendations include corrective instructions for addressing identified compliance risks.

8. The computer-implemented method of claim 1, wherein the artificial intelligence engine employs machine learning models trained on a dataset comprising historical financial planning meetings and debriefing outcomes to refine detection of deviations from established financial planning practices.

9. A system for providing real-time, AI-powered debriefing and feedback for financial planning client meetings, the system comprising:
a data acquisition module configured to capture audiovisual signals and associated metadata from a financial planning client meeting; a processor; a memory operatively connected to the processor; an artificial intelligence engine stored in the memory and executable by the processor, the artificial intelligence engine configured to: analyze the captured audiovisual signals and associated metadata to detect deviations from established financial planning practices and regulatory compliance requirements, the analysis including evaluation of verbal communications and non-verbal cues of a financial planner and a client; and determine a debriefing outcome based on the analysis, the debriefing outcome identifying one or more areas for improvement in adherence to recommended planning processes; and generate real-time feedback recommendations structured to facilitate experiential learning ; and store the captured audiovisual signals, associated metadata, and generated feedback recommendations for iterative comparison with historical meeting data to track performance trends;
a communications module configured to deliver the generated real-time feedback recommendations to the financial planner during or immediately following the client meeting; and a secure data storage module configured to store meeting data and feedback recommendations in accordance with applicable privacy standards.

10. The system of claim 9, wherein the data acquisition module comprises:
one or more cameras and one or more microphones configured to capture the audiovisual signals and associated metadata from the financial planning client meeting.

11. The system of claim 9, wherein the artificial intelligence engine comprises:
a natural language processing and large language models module configured to extract semantic and syntactic features from the verbal communications of the financial planner and client; and an image processing module configured to analyze facial expressions, gestures, and body movements.

12. The system of claim 9, wherein the artificial intelligence engine is further configured to:
detect significant deviations from established regulatory compliance requirements; and generate corrective feedback recommendations for addressing identified compliance risks.

13. The system of claim 9, wherein the real-time feedback recommendations are structured in accordance with a framework comprising:
a defusing module configured to address emotional responses; a debriefing module configured to assess planning processes and client communications; and a deepening module configured to facilitate application of feedback in subsequent client meetings.

14. The system of claim 9, wherein the communications module is configured to deliver the generated real-time feedback recommendations via an interactive mobile device interface.

15. The system of claim 9, wherein the secure data storage module is configured to:
store meeting data and feedback recommendations in accordance with applicable privacy standards including HIPAA and SOC 2; and maintain audit logs for compliance monitoring.

16. The system of claim 9, further comprising a user interface operatively connected to the processor, the user interface configured to display historical performance trends and debriefing outcomes derived from iterative comparisons of analyzed meeting data.

17. The system of claim 9, wherein the artificial intelligence engine employs machine learning models trained on a dataset comprising historical financial planning meetings and debriefing outcomes to continuously refine detection of deviations from established financial planning practices.

18. The system of claim 9, wherein the processor is configured to perform real-time analysis of the audiovisual signals to generate immediate debriefing feedback recommendations during or immediately following the financial planning client meeting.

19. The system of claim 9, wherein the artificial intelligence engine is further configured to:
update a knowledge base iteratively based on feedback from successive client meetings to enhance the accuracy of performance trend tracking and feedback recommendation generation.
